(19) United States
(12) Patent Application Publication
(10) Pub. No.: US 2013/0068913 A1
(43) Pub. Date: Mar. 21, 2013

(54) Thin Wire Flat Screen Mount

(71) Applicant: Michael F. Bouissiere, Yorba Linda, CA (US)

(72) Inventor: Michael F. Bouissiere, Yorba Linda, CA (US)

(73) Assignee: Premier Mounts, Anaheim, CA (US)

(21) Appl. No.: 13/238,909

(22) Filed: Sep. 21, 2011

(51) Int. Cl. F16M 13/02; B23P 11/00; A47G 1/16

(52) U.S. Cl. 248/493; 29/428

(57) ABSTRACT

A flat panel display mounting system and method for hanging a display on a wall or the like. The mounting system employs at least two outrigger spindles attached to the back of a display and by flexible wire to a central core element which is removably and slideably attached to a wall. The wire passes from the spindles to the core where it is tensioned within a one way sliding lock using a wedge element which traps the wire between the wedge and a housing Another embodiment includes additional spindles with a kick stand to tilt the panel away from the wall for connection access.

### TECHNICAL FIELD

The present invention is directed to a flat screen display mount.

### BACKGROUND

Since the invention of flat plan displays, there has been a need to find wall mounting systems to support them. As displays became thinner and lighter (for example, LED or Organic LED technology) the need to support heavy screens has diminished. At the same time, there has been a consumer desire for thinner, low profile, lighter mounts commensurate with the thinner lighter screens.

One solution would be mounting a screen in the same way as a photograph would be mounted on a single or double pivot point. Aside from being insecure, it is difficult to compensate if hung off the center of gravity. Furthermore, there is no effective way to title the monitor for best viewing angle.

In addition, mounts are often installed by a single person, so there is a need to adjust and tension the mount with only one or two hands.

### BRIEF SUMMARY

The disclosure encompasses many embodiments. One such embodiment is detailed below in summary fashion. Please understand that this summary does not encompass the entire disclosure but is provided to assist the reader in reviewing the entire disclosure and claims which also constitute part of the disclosure.

A flat panel display system is disclosed having a mounting plate attachable to a fixed surface, said plate having an upper insertion end and a lower end, said plate having a generally planar mount surface and a pair of converging sidewalls extending from the mount surface, said sidewalls converging toward the lower end; a tapered central core sized to be received between said sidewalls; said core including left and right wire passages and a central passage; the central passage including wire slide lock including a wide portion and a narrow portion, and a floating element therebetween, capable of moving between said wide and narrow portions; at least one left and right upper spindles capable of being affixed to the display at least one flexible wire having one end free end and a second end passing thru said slide lock and extending to each of said spindles and then returning thru said slide lock, so that said free ends can be drawn tight and locked by said slide lock thereby tensioning the wire which extends between the spindle and core.

Also disclosed is a system wherein said system further includes a pair of lower spindles capable of being affixed to the display, and wherein said at least one wire passes thru said lower spindles.

Also disclosed is a system wherein said wire passes from the core to one of the upper spindles and then to the most adjacent lower spindle, then back to the core, then to the other upper spindle and then to the remaining lower spindle and back to the core.

Also disclosed is a system wherein another wire passes from the core to one of the a lower spindle, then back to the core, then to the other lower spindle and back to the core and thru the lock.

Also disclosed is a system wherein the core further includes a wire take up winder including a central spindle extending outwardly from the core and flange generally orthogonal to the core and spaced therefrom to provide a storage space for excess wire.

Also disclosed is a system further including a magnet on said core for aligning and engaging said plate when being slid into said tapered sidewalls.

Also disclosed is a system wherein lower spindles further include a kickstand for switchable tilting the display away from the surface to access the rear of the display.

Also disclosed is a system wherein said wire is looped at least once around each upper spindle.

Also disclosed is a system further including a housing with a passage therethrough from end to end of sufficient size to allow passage of at least one wire, a wedge shaped element at least partially within said housing and slideable between ends thereof, so that frictional engagement of the wire with the wedge will tend to draw engage the wire between the wedge and the housing thereby inhibit the movement of the wire.

Also disclosed is a system wherein the wedge includes a guide pin which passes at least partway thru the housing to maintain alignment of the wedge.

Also disclosed is a system wherein said housing includes tapered inner walls adjacent the wedge.

Also disclosed is a system further including a spring bias member configured to urge the wedge toward engagement with said wire to inhibit the movement of the wire.

Also disclosed is a system wherein the lock allows withdrawal of a portion of the wire therethrough to cause tensioning of the wire, and further includes a release pin for retracting the wedge relative to the wire.

Also disclosed is a flat panel display system having a central core attachable to a fixed surface; said core including left and right wire passages and a central passage generally orthogonal to the left and right passages; the central passage including wire slide lock including a housing and a floating wedge element therein and a passageway for wire, said wedge capable of moving between upper and lower positions to lock a wire between the wedge and housing; at least one left and right upper spindles capable of being affixed to the display; at least one flexible wire having one end free end and a second end passing thru said slide lock and extending to each of said spindles and then returning thru said slide lock, so that said free ends can be drawn tight and locked by said slide lock thereby tensioning the wire which extends between the spindle and core.

Also disclosed is a system wherein the system further includes a pair of lower spindles capable of being affixed to the display, and wherein said at least one wire passes thru said lower spindles.

Also disclosed is a system wherein the wire passes from the core to one of the upper spindles and then to the most adjacent lower spindle, then back to the core, then to the other upper spindle and then to the remaining lower spindle and back to the core.

Also disclosed is a system wherein another wire passes from the core to one of the a lower spindle, then back to the core, then to the other lower spindle and back to the core and thru the lock.

Also disclosed is a method of mounting a flat panel display from a wall surface comprising the steps of:

a. attaching at least two spindles spaced part, to the back of the display;

b. connecting a loop of wire around each of said spindles and back to a central mounting core affixed to a wall,

c. tensioning the wire at said core;

d. locking the tensioned wire by drawing it thru a passage containing a locking wedge biased against the wire.

Also disclosed is a flat panel display a core including left and right wire passages and a central passage; the central passage including wire slide lock including a wide portion and a narrow portion, and a floating element therebetween, capable of moving between said wide and narrow portions; at least one left and right upper spindles capable of being affixed to the display at least one flexible wire having one end free end and a second end passing thru said slide lock and extending to each of said spindles and then returning thru said slide lock, so that said free ends can be drawn tight and locked by said slide lock thereby tensioning the wire which extends between the spindle and core.

Also disclosed is a flat panel mounting system is disclosed having a wall plate with a pair of converging side flanges, the flanges configured removably engage and confine the mounting core block which has tapered edges sized to be removably received within said converging side flanges so that gravity and the weight of the display panel will secure the engagement between the wall plate and the core block.

The core block manages cable flow and slipping, including a central passageway for a pair of cables which pass therethru. The central passageway includes a cinching element which can releaseably prevent slippage of the cables therethrough.

The core also includes a cable path splitter for directing at least one cable in opposite directions to at least one pair of outrigger spindles, which are attached to the display and the wall.

In one configuration, cables pass thru the central core and outward to left and right upper spindles, wrap around the spindles and follow a return path to the core. The ends of the cables starting from and ending at the core pass thru the cinch and once tightened are prevented from slipping/loosening by a sliding wedge block which engages the cables when they move in a loosening direction.

In another embodiment a further set of lower spindles which provide lower support for the display and also include a kickstand element which and switchable hold the panel away from the away to allow access to the cable connection area of the display. In this embodiment the cable path may be different, where the cable passes through the upper (first) spindles and continues on to the lower spindles, and then returns to the core, either directly or passing back thru the first upper spindles.

By this construction, the spindles and core are always unitary (connected together) by cables and are not free to get separated/lost from the mount, but are also freely movable to required locations. For example the spacing between upper spindles will depend on the size of the display and its mounting hole pattern. Since the cables may slide through the spindles, the spacing can be changed.

In the preferred embodiment the wire is self tightening around the spindles by wrapping at least one turn of the wire around the core of the spindle which, under tension, engages the wire around the core and prevents movement. In essence, when the display is hung, the cables will not slide through the spindles or the core because of the locking mechanisms stated above.

### BRIEF DESCRIPTION OF THE SEVERAL VIEWS OF THE DRAWINGS

FIG. 1 is an exploded drawing of a wire mount.

FIG. 2 is a plan view of one embodiment.

FIG. 3 is a cutaway view of an outrigger spindle with grommet removed.

FIG. 4 is close of fragmentary view of a portion of the core element showing wire paths schematically.

FIG. 5 is a fragmentary close up view of the lower portion of the core and mounting plate with screw lock.

FIG. 6 is a side cutaway view of the mounting plate and core with wall mounting screw.

FIG. 7 is perspective view of a spindle cover.

FIG. 8 is an end view of the subject of FIG. 7.

FIG. 9 is a side view taken along lines A-A of FIG. 8.

FIG. 10 is close up fragmentary view of a portion of FIG. 7.

FIG. 11 is a top plan view of the spindle cover of FIG. 7.

FIG. 12 is a perspective view of the spindle.

FIG. 13 is a bottom plan view.

FIG. 14 is a fragmentary view of FIG. 12.

FIG. 15 is a side view of FIG. 12.

FIG. 16 is a fragmentary view of FIG. 19 along lines C-C.

FIG. 17 is a fragmentary view of FIG. 19 along lines A-A.

FIG. 18 is a side view of a spindle.

FIG. 19 is a top view of a spindle.

FIG. 20 is another side view of a spindle.

FIG. 21 is a top plan view of a mounting plate.

FIG. 22 is a perspective view of FIG. 21.

FIG. 23 is a perspective view of the slip lock feature removed from the core.

FIG. 24 is a top plan of the housing in FIG. 23.

FIG. 25 is a bottom plan view of FIG. 23.

FIG. 26 is an end view.

FIG. 27 is a view taken along lines C-C of FIG. 25.

FIG. 28 is the other end view of FIG. 23.

FIG. 29 is a side view of FIG. 23.

FIG. 30 is a top plan view of FIG. 29 taken along lines A-A.

FIG. 31 is a close up fragmentary view of the subject of FIG. 30.

FIG. 32 is a plan view of a kick stand element.

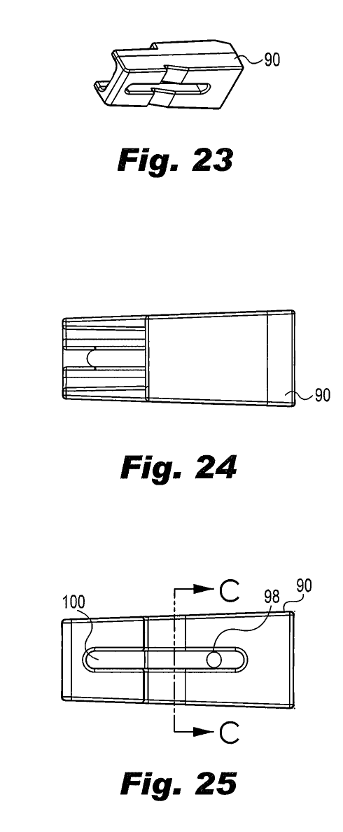

FIG. 23 is a perspective view of a sheath/cover of the kick stand.

FIG. 34 is a plan view of a kick stand with spindle.

FIG. 35 is a side view of FIG. 34.

FIG. 36 is a side plan view of a core and wall plate.

FIG. 37 is a schematic view of an alternate embodiment having upper and lower spindles.

### DETAILED DESCRIPTION

The display mount system disclosed is shown is several embodiments, the most prominent of which are 1) two outrigger spindles system and 2) a four spindle system with a second set of lower spindles with a kickstand element. The mount system of various elements connected by flexible filaments can also be used for mounting a variety of object other than display panels to a wall or other surface.

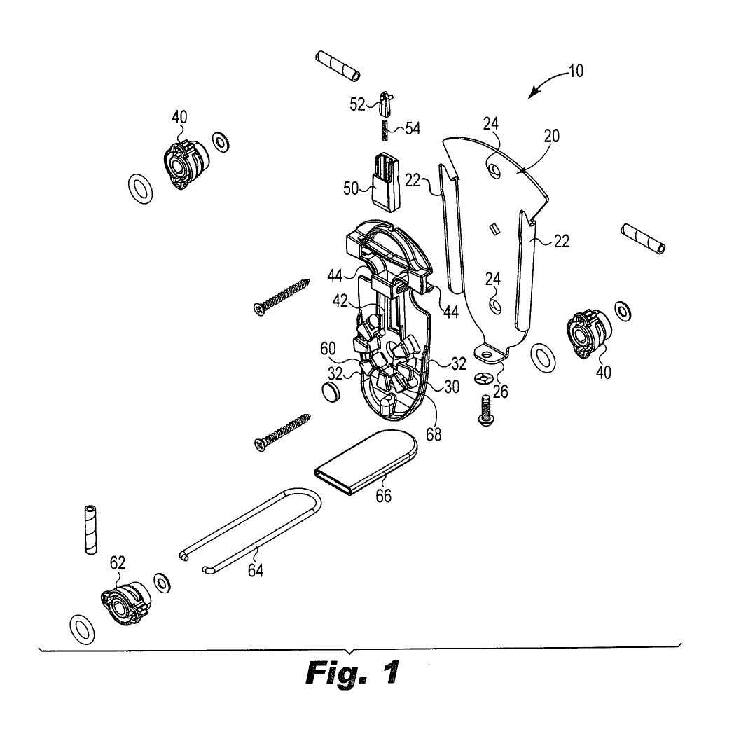

FIG. 1 shows and exploded view of many elements of the mount system 10 with a mounting plate 20, most likely intended for a wall surface but other surfaces are included. Plate 20 has converging sidewall with like converging flanges 22, mounting holes 24 and a safety attachment 26

Core element 30 is preferably likewise tapered at its sidewalls 32 so that it can be received within walls 22 and under the force of gravity, be snugly engaged by the common taper.

Outrigger left and right spindles 40 will be shown attached to the core in later figures by wires. The preferred configuration has spindles or attachment points configured to be attached to the back of the display at the display's attachment points, usually threaded and simultaneously support the display by a wire/filament, by attachment back to the central point or core which is affixed to a surface, usually a wall. The spindles preferably have a central aperture for a fastener mountable to the display, around which is a hub on which wires will be wrapped and slide during adjustment and over the hub is a structure with passages for the wires, and finally a cap on the spindle with outlets for the wires.

The core has a central section 42 and two side passages 44 which provide paths for wires. A slide lock 50 preferably resides in the central section 42 and contains a slideable locking wedge 52 biased upwardly by spring bias member 54. See also FIG. 6 The purpose of the slide lock is to allow the user to apply tension to the system of wires which link the core to the spindles and thus support the screen. The preferred lock is a one way slip lock which allows the user to tighten and then release the tension wires, without reverse slippage. A release mechanism is provided to release tension and restart the process if needed.

The core 30 includes a wire take up winder 60 which has a plurality of flanges spaced from the core base by a spindle.

A lower spindle 62 is shown with a kick stand loop 64 and rubber non scratch sheath 66. Core 30 may include a magnet 68 which will cause the core to adhere to the wall plate during installation so that alignment is simplified.

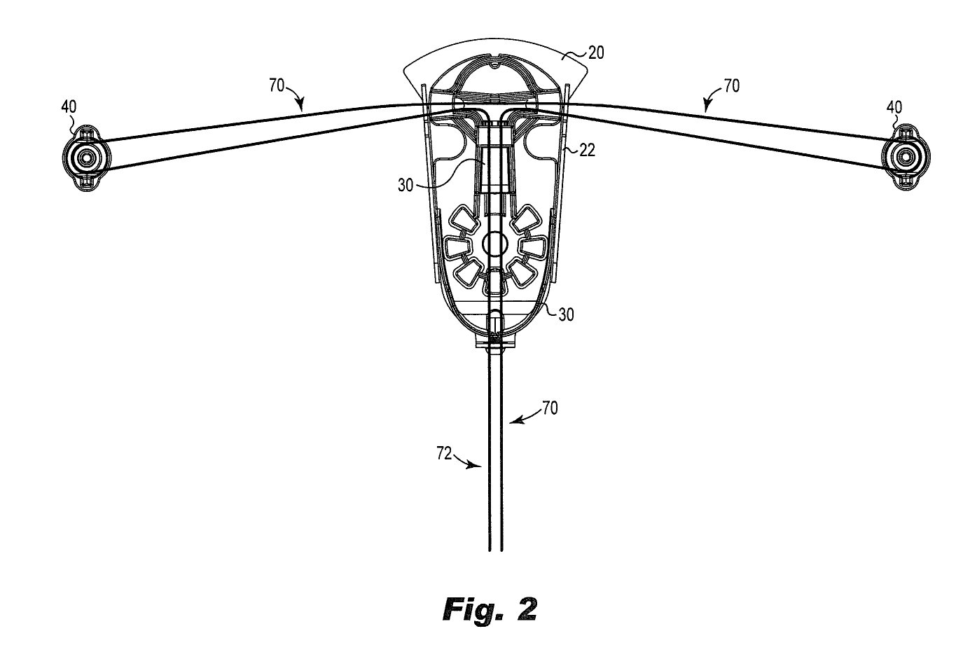

FIG. 2 schematically shows the path of wires 70. In one embodiment a single wire is threaded thru the core and all spindles. It is possible for separate wires to extend to each or several spindles and back to the core. The preferred construction has the core attached to the wall, with or without the wall plate, and the spindles are attached to the back of the display panel at its usually attachment points with fasteners. Thus, in the preferred embodiment, the wire provides the only connection between the panel and the core/wall. Thus it is desirable to tension the wire to the point where the wire extends between the upper spindles and core without deflection, though in reality, that means a minimum amount of arcing. On the other hand, adjustment in the tensioning allows the user to raise or lower the height of the display is desired after affixing the core.

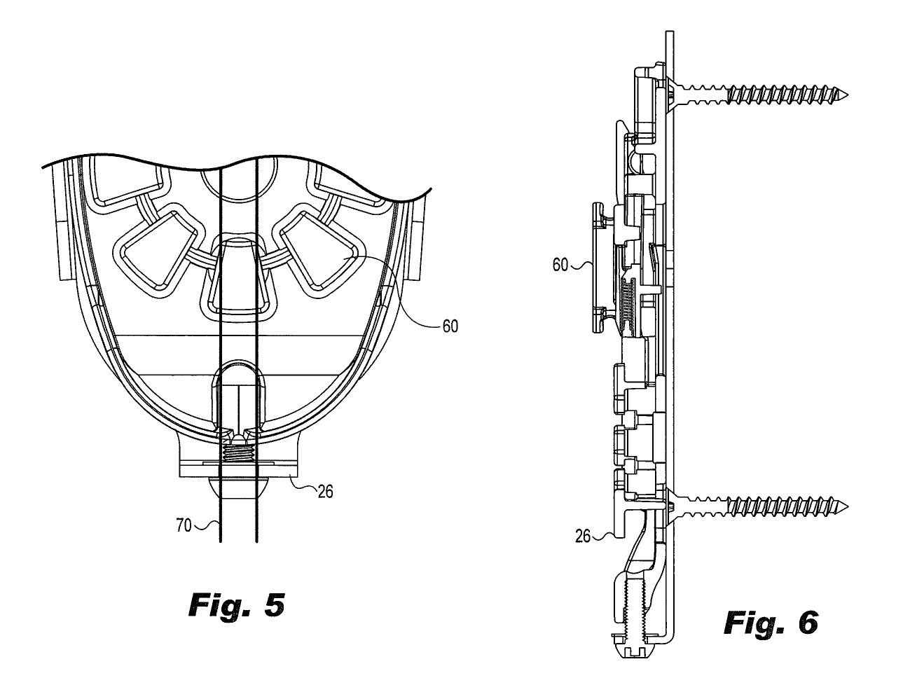

In one embodiment the wire passes thru the sliding lock, out to the left or right passage 44 and to the left or right spindle 40. The wire the loops the spindle, preferably with one entire turn on the spindle, though it can be more or less, and then returns to the left or right passage 44 and down thru the slideable lock 50. See FIGS. 4 and 5. By virtue of the wedge or other locking mechanism (explained later) the wire may be tensioned by pulling on the lower pair of wires 72 and will remain tensioned after release. There is a separate de-tensioning release in lock 50 as shown in other figures.

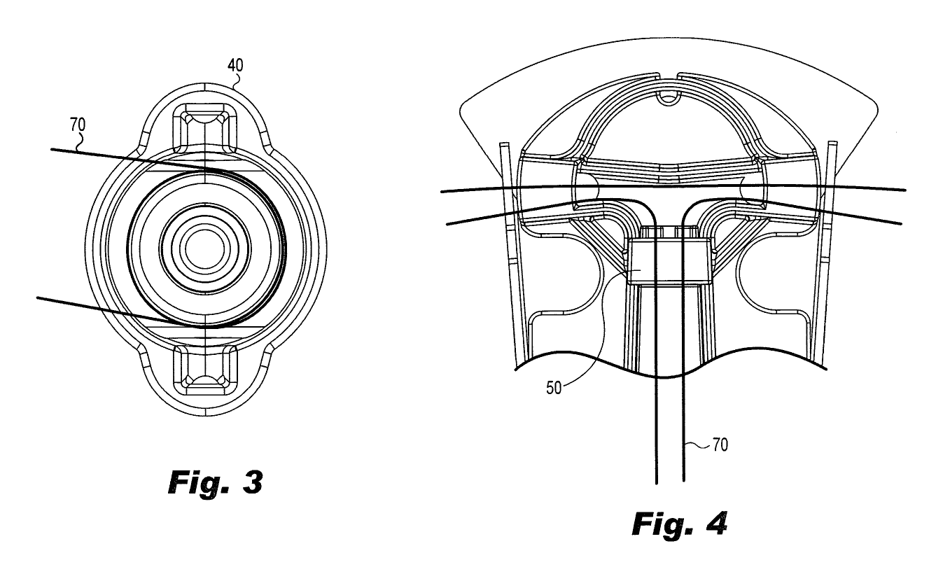

FIG. 3 shows a wire path around the spindle 40. If wire 70 is looped one full turn, it will not slide as easily and help manage installations where the center of gravity is not exactly correct and it will inhibit the turning moment, ie the wire will tend to frictionally engage its coaxial hub within the spindle so that it will not slide freely even if the tension is low. If the wire is a braided steel cable, there will be considerable friction between overlapping strands of cable wrapped around the hub.

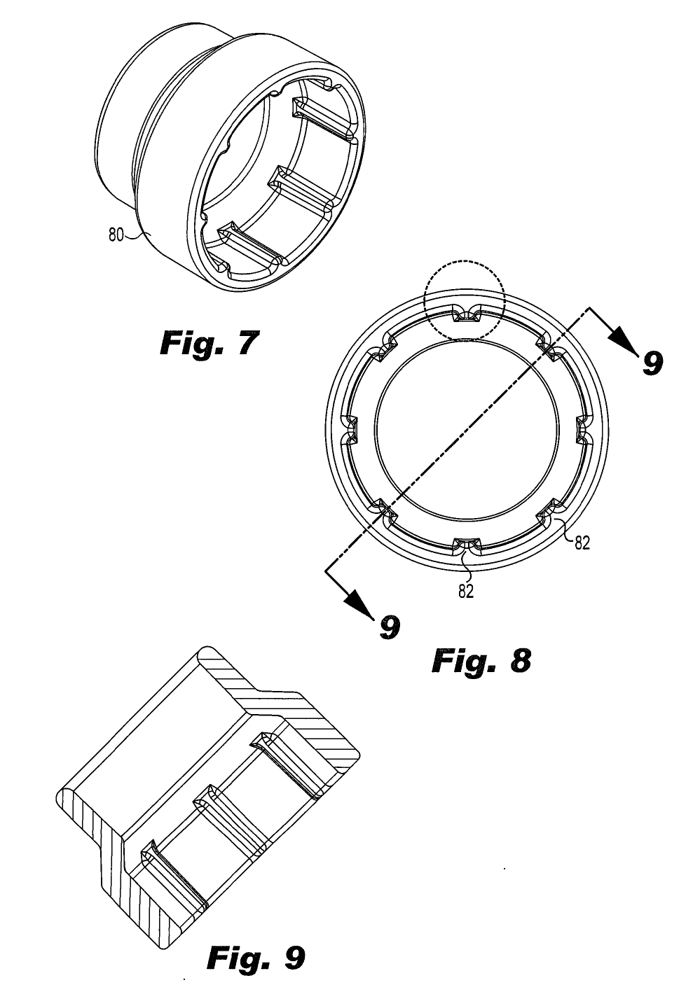

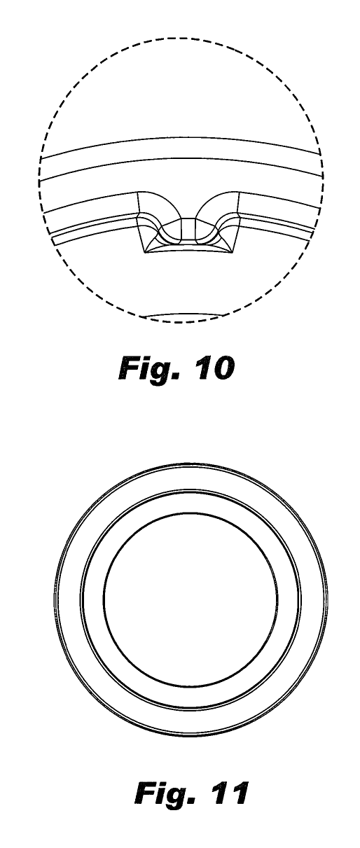

FIGS. 7-11 illustrate spindle covers 80 which are optional but cover the spindles after attachment to the display. Gaps 82 provide a passage way for the wires 70

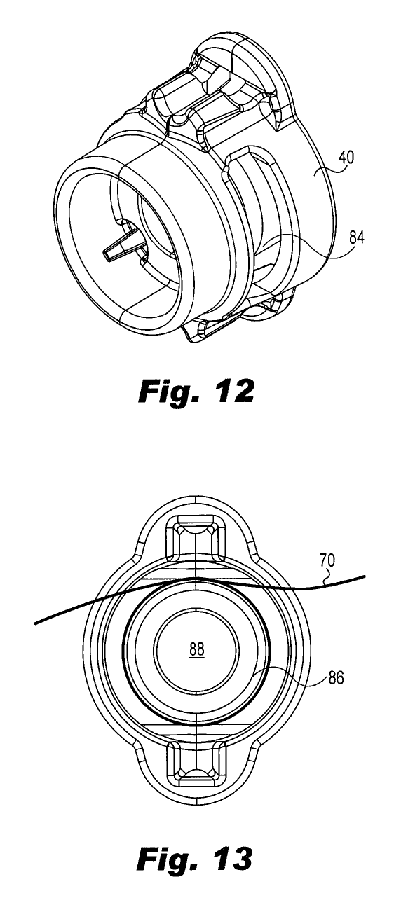

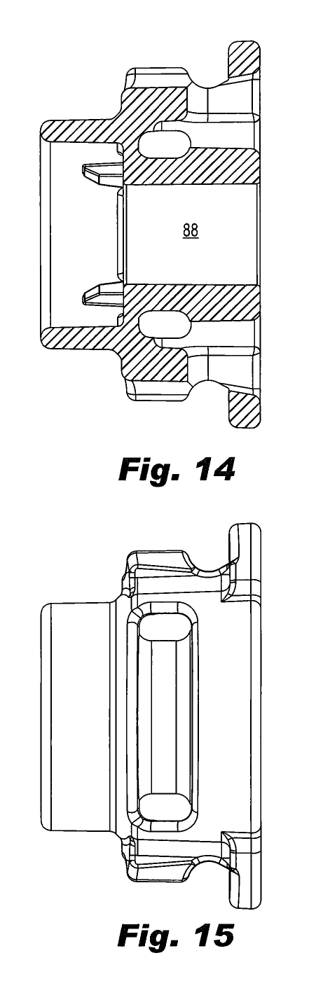

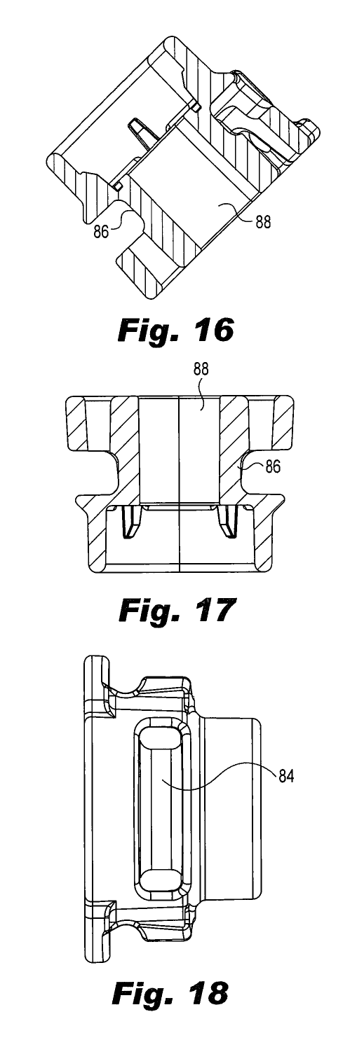

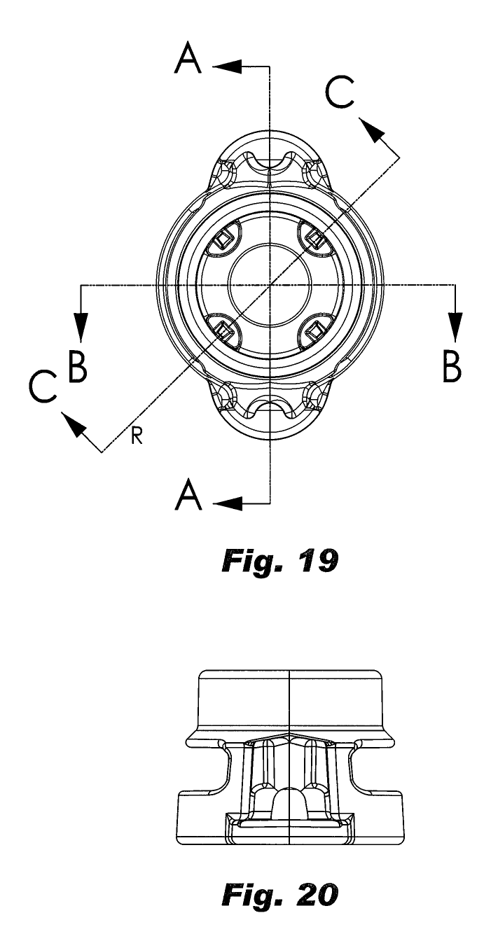

FIGS. 12-20 illustrate a preferred spindle 40 with a preferred wire path shown in FIG. 13. The spindle has apertures 84 for entry and exit of wires 70 and a hub 86 around which the wires engage. A fastener, not shown, passes thru aperture 88 and into the display anchor point. The spindle is configured to have the fastener recessed so that the cover 80 will fit.

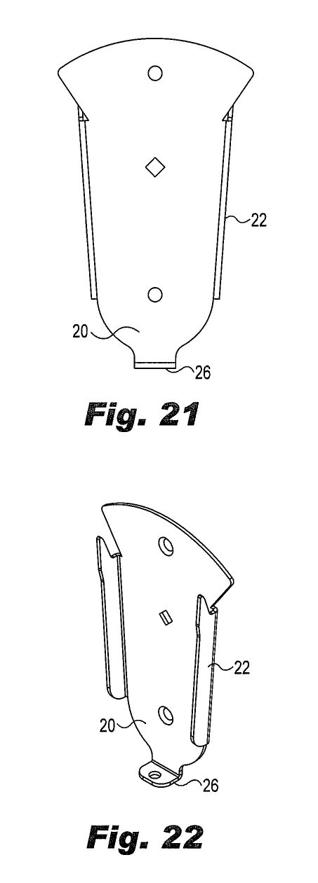

FIGS. 21-22 show the (wall) mounting plate with converging sidewalls 22 and lock flange 26.

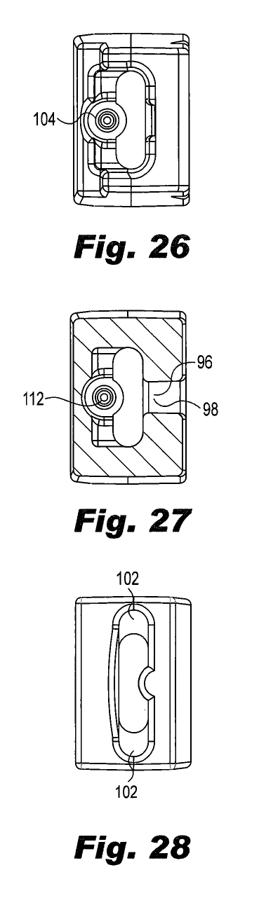

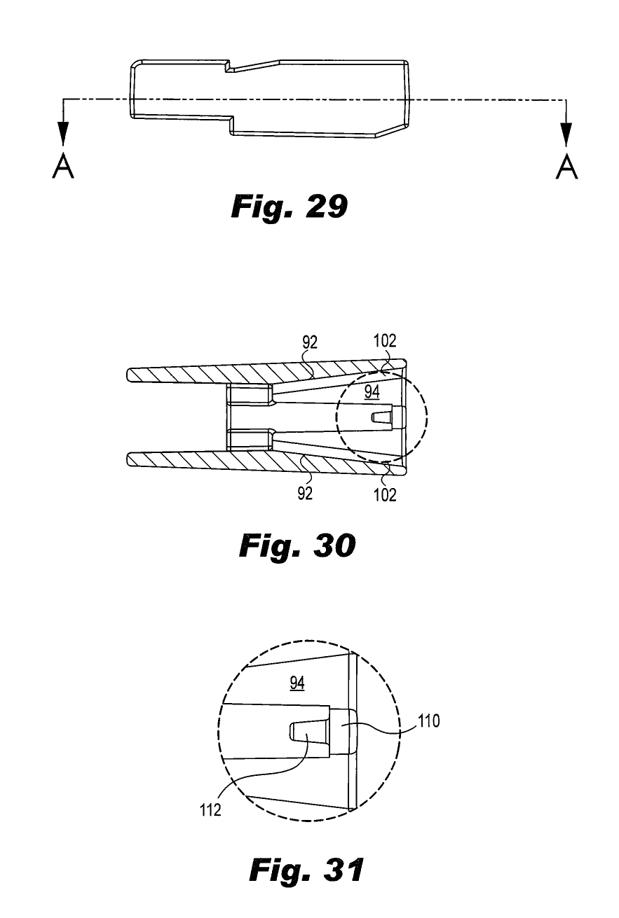

FIGS. 23-30 illustrated the preferred slide lock mechanism. It is understood that various other one way locking devices may be used also. In the preferred embodiment, housing 90 has tapered inner walls 92 (optional). See FIG. 30 and a tapered floating wedge 94 which resides in the housing. The housing includes an alignment and release slot 96 (FIG. 27) which receives a pin 98 which extends orthogonally from the wedge. The pin 98 helps keep the wedge generally centrally within the housing and provides a way to manually release the wire tension. The pin 98 extends thru slot 100. To maintain the wedge biased against the wire 70 and wire passage 102 (FIG. 30), a spring bias member 104 resides between a shelf 110 on the wedge and the housing. Shelf 110 has an orthogonal projection 112 which receives and holds a spring 104 thru its hollow core. It is possible to have either the housing or the wedge have tapered walls, or both, as shown. It is also possible to have other means for engagement of the wire (ie locking) such as a wedge element which is not tapered but has serrations or stair step teeth. Likewise the inner walls of the housing could have such or other frictional elements. Wire passage 102 is large enough to accommodate the two wires of the preferred embodiment or more wires of other embodiments which have multiple wire routes back to the core.

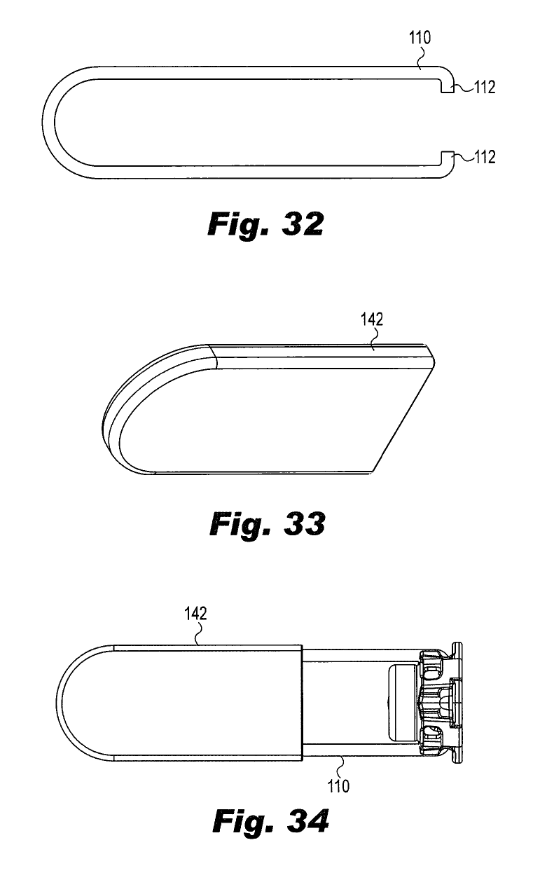

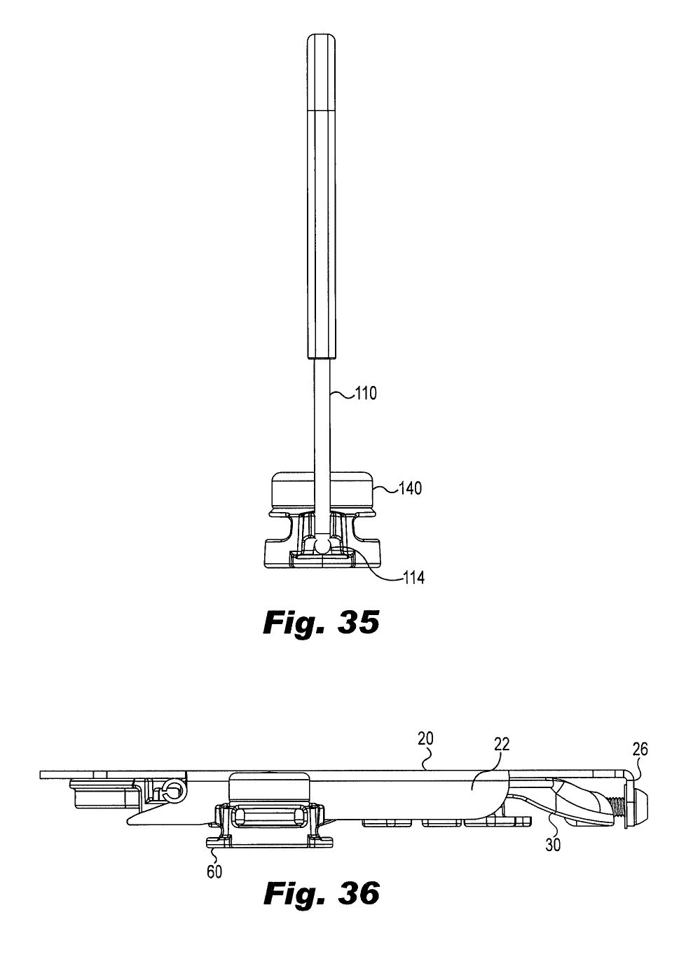

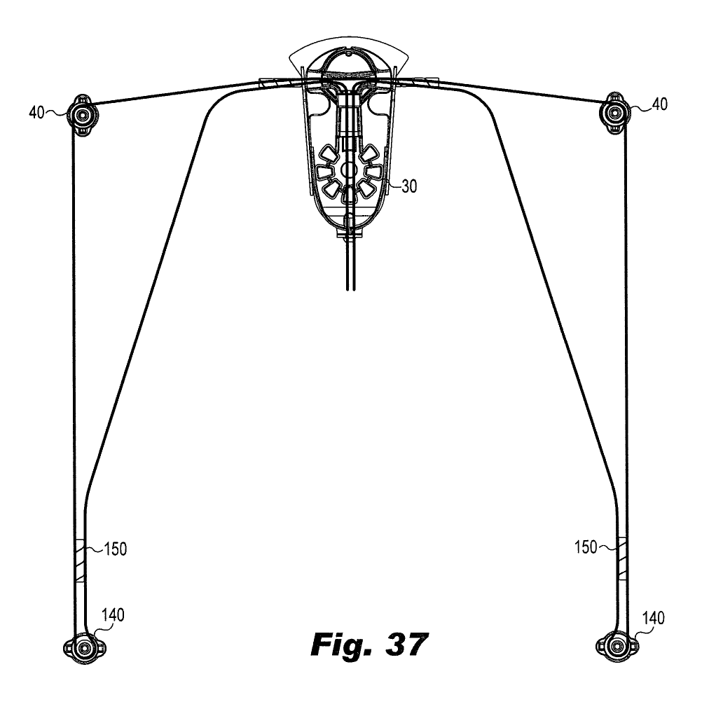

It is helpful to tilt the display away from the wall while attaching cables. Therefore in the second embodiment shown in FIGS. 32-37, a second set of lower spindles 140 provided. The lower spindles can be identical to spindles 40 or they may have a “kick stand” wire 110 which is switchable to tilt the display away from the wall while cables are being attached and then the kick stand can be flipped down.

The kick stand wire 110 includes a pair of hinge pin portions 112 which are received apertures 114 in the spindles 140. A non scratch (rubber) sheath 142 can be applied to the wires 110 to protect the wall surface.

It is also possible to place the kick stand feature on the upper spindles as a way to tilt the screen. The kick stand or spindles can be telescopic with set points/screws to secure the degree of tilt. For example, the spindle covers could include a kick stand pivotally attached thereto or have a telescopic element to set a tilt. It is also possible to skew the tilt by unequal adjustment of the kickstand feature so that the display is titled and angled. Many combination are possible because of the flexibility of wire over rigid element of traditional displays.

FIG. 37 shows the preferred wiring pattern of a 4 spindle system. A single wire is shown 70 passes between both upper spindles 40 and from an upper spindle to a lower 140, and back to the core 30 and thru lock 50.

Alternative wiring patterns are possible such as the upper and lower spindles being wired back to the core without passing through the other set of spindles. That will result in 4 wires passing thru the lock 50 or that two locks 50 will be provided side by side or end to end. For example, the upper right spindle could be connected to the lower left spindle in a cross pattern. In the preferred embodiment the tensioning of all wires takes place centrally, preferably at the core so that a user can tension the entire system in one place and perhaps with one hand.

Passage guides 150 (FIG. 37) may optional be provided with wall or preferably on display by mounts (or adhesive) to guide the wires on the longer runs adjacent the wall or display.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

1. A flat panel display system comprising:
a. a mounting plate attachable to a fixed surface, said plate having an upper insertion end and a lower end, said plate having a generally planar mount surface and a pair of converging sidewalls extending from the mount surface, said sidewalls converging toward the lower end;
b. a tapered central core sized to be received between said sidewalls; said core including left and right wire passages and a central passage;
c. said central passage including wire slide lock including a wide portion and a narrow portion, and a floating element therebetween, capable of moving between said wide and narrow portions;
c. at least one left and right upper spindles capable of being affixed to the display;
d. at least one flexible wire having one end free end and a second end passing thru said slide lock and extending to each of said spindles and then returning thru said slide lock,
so that said free ends can be drawn tight and locked by said slide lock thereby tensioning the wire which extends between the spindle and core.

2. The system of claim 1 wherein said system further includes a pair of lower spindles capable of being affixed to the display, and wherein said at least one wire passes thru said lower spindles.

3. The system of claim 2 wherein said wire passes from the core to one of the upper spindles and then to the most adjacent lower spindle, then back to the core, then to the other upper spindle and then to the remaining lower spindle and back to the core.

4. The system of claim 2 wherein another wire passes from the core to one of the a lower spindle, then back to the core, then to the other lower spindle and back to the core and thru the lock.

5. The system of claim 1 wherein the core further includes a wire take up winder including a central spindle extending outwardly from the core and flange generally orthogonal to the core and spaced therefrom to provide a storage space for excess wire.

6. The system of claim 1 further including a magnet on said core for aligning and engaging said plate when being slid into said tapered sidewalls.

7. The system of claim 2 wherein said lower spindles further include a kickstand for switchable tilting the display away from the surface to access the rear of the display.

8. The system of claim 1 wherein said wire is looped at least once around each upper spindle.

9. The slide wire lock of claim 1 further including a housing with a passage therethrough from end to end of sufficient size to allow passage of at least one wire, a wedge shaped element at least partially within said housing and slideable between ends thereof, so that frictional engagement of the wire with the wedge will tend to draw engage the wire between the wedge and the housing thereby inhibit the movement of the wire.

10. The system of claim 9 wherein the wedge includes a guide pin which passes at least partway thru the housing to maintain alignment of the wedge.

11. The system of claim 9 wherein said housing includes tapered inner walls adjacent the wedge.

12. The system of claim 9 further including a spring bias member configured to urge the wedge toward engagement with said wire to inhibit the movement the wire.

13. The system of claim 9 wherein said lock allows withdrawal of a portion of the wire therethrough to cause tensioning of the wire, and further includes a release pin for retracting the wedge relative to the wire.

14. A flat panel display system comprising:
a. a central core attachable to a fixed surface; said core including left and right wire passages and a central passage generally orthogonal to the left and right passages;
b. said central passage including wire slide lock including a housing and a floating wedge element therein and a passageway for wire, said wedge capable of moving between upper and lower positions to lock a wire between the wedge and housing;
c. at least one left and right upper spindles capable of being affixed to the display;
d. at least one flexible wire having one end free end and a second end passing thru said slide lock and extending to each of said spindles and then returning thru said slide lock,
so that said free ends can be drawn tight and locked by said slide lock thereby tensioning the wire which extends between the spindle and core.

15. The system of claim 14 wherein said system further includes a pair of lower spindles capable of being affixed to the display, and wherein said at least one wire passes thru said lower spindles.

16. The system of claim 15 wherein said wire passes from the core to one of the upper spindles and then to the most adjacent lower spindle, then back to the core, then to the other upper spindle and then to the remaining lower spindle and back to the core.

17. The system of claim 16 wherein another wire passes from the core to one of the a lower spindle, then back to the core, then to the other lower spindle and back to the core and thru the lock.

18. A method of suspending a flat panel display from a wall surface comprising the steps of:
a. attaching at least two spindles spaced part, to the back of the display;
b. connecting a loop of wire around each of said spindles and back to a central mounting core affixed to a wall,
c. tensioning the wire at said core;
d. locking the tensioned wire by drawing it thru a passage containing a locking wedge biased against the wire.
